(19) United States
(12) Patent Application Publication
(10) Pub. No.: US 2013/0272729 A1
(43) Pub. Date: Oct. 17, 2013

(54) MARKING APPARATUS

(71) Applicants: KABUSHIKI KAISHA TOSHIBA, Tokyo (JP); TOSHIBA TEC KABUSHIKI KAISHA, Tokyo (JP)

(72) Inventor: Tomoyuki Kato, Shizuoka-ken (JP)

(73) Assignees: TOSHIBA TEC KABUSHIKI KAISHA, Tokyo (JP); KABUSHIKI KAISHA TOSHIBA, Tokyo (JP)

(21) Appl. No.: 13/859,386

(22) Filed: Apr. 9, 2013

Related U.S. Application Data
(60) Provisional application No. 61/622,644, filed on Apr. 11, 2012.

(51) Int. Cl. G03G 15/00; G03G 15/20

(52) U.S. Cl. CPC G03G 15/2039
USPC 399/38; 399/340

(57) ABSTRACT

In accordance with an embodiment, a marking apparatus, configured in an image forming apparatus for forming an image on a sheet by using a fadable record material which is faded when the heat with a specified fading temperature is applied, and to mark a marker at a specified position of the sheet comprises a marking record material configured to color when the heat in a first temperature range is applied, fade the color when the heat in a second temperature range lower than the first temperature range is applied, and have the reversibility of alternately carrying out color-fading and coloring, a marker printing unit configured to print the marker at the specified position of the sheet by using the marking record material and a heating unit configured to heat the marker in the second temperature range.

### CROSS-REFERENCE TO RELATED APPLICATIONS

This application is based upon and claims the benefit of priority from U.S. Provisional Application No. 61/622,644 filed on Apr. 11, 2012; the entire contents of which are incorporated herein by reference.

### FIELD

Embodiments described herein relate to a technology realizing developing a marker on a sheet subjected to image fading to enable the sheet to become a reuse sheet.

### BACKGROUND

Conventionally, in an electronic photographic apparatus, an electrostatic latent image formed on a photoreceptor by exposing an image on the photoreceptor is developed by using a toner and is subjected to visualization; after a toner image is transferred on a record medium, a fixing apparatus is used for fusing and fixing the toner image formed on the record medium; and thus, a permanent image is formed.

On the other hand, an apparatus carrying out image formation on the record medium by the toner using a color material with a property to be subjected to color fading by heating is proposed, and an image forming apparatus using a color-fadable toner which can cut the combination of a pigment and a color developing agent to fade a color by the heating to carry out the image formation is provided. As a literature disclosing such a prior technology, the Japanese patent application publication No. 2005-205625 report is known.

In the apparatus, the effects that the sheet can be repeatedly used, wastes are reduced and CO2 is reduced are realized.

On the other hand, in the image forming apparatus using such an fadable toner described above, a detachable or integral image fading apparatus is needed, and moreover, the reuse time in which the fading of the record medium using the color-fadable toner is also included is limited.

In addition, in the condition that the record medium on which the image formation is carried out by using the color-fadable toner is put into the fading apparatus, the work of carrying out identification and the like on the record medium on which the image is printed previously by using the fadable toner and the record medium on which the image is printed by using a conventional non-fadable toner is expected.

Therefore, the color of the color-fadable toner is enabled to be blue and the like to carry out the identification on the record medium on which the image is formed by using the fadable toner and the record medium on which the image is formed by using the non-color-fadable toner.

However, when the color-fadable image is faded, whether or not the sheet is the reuse sheet is not clear, and therefore, whether or not the sheet of a white sheet is the reuse sheet can be simply discriminated is expected.

### BRIEF DESCRIPTION OF THE DRAWINGS

FIG. 1 is a skeleton diagram illustrating an image forming apparatus comprising a marking apparatus of a first embodiment;

FIG. 2 is a skeleton diagram illustrating a color fading apparatus comprising a marking apparatus of a second embodiment;

FIG. 3 is a drawing illustrating a printing position at which a marker is identified; and

FIG. 4 is a block diagram of a control apparatus controlling all actions of the marking apparatus.

### DETAILED DESCRIPTION

In accordance with one embodiment, a marking apparatus configured in an image forming apparatus for forming an image on a sheet by using a fadable record material which is faded when the heat with a specified fading temperature is applied and to mark a marker at a specified position of the sheet.

The marking apparatus includes a marking record material configured to color when the heat in a first temperature range is applied, fade the color when the heat in a second temperature range lower than the first temperature range is applied, and have the reversibility of alternately carrying out color-fading and coloring, a marker printing unit configured to print the marker at the specified position of the sheet by using the marking record material and a heating unit configured to heat the marker in the second temperature range.

In accordance with one embodiment, a marking apparatus configured in a fading apparatus for fading an image formed on a sheet by using a fadable record material which is faded when the heat with a specified fading temperature is applied, and to mark a marker at a specified position of the sheet. The marking apparatus includes a marking record material configured to color when the heat in a first temperature range is applied, fade the color when the heat in a second temperature range lower than the first temperature range is applied, and have the reversibility of alternately carrying out color-fading and coloring, a marker printing unit configured to print the marking record material at the specified position of the sheet and a heating unit configured to heat the marker in the first temperature range.

A fadable record material means a decolorizable material when the heat is applied to itself.

### A First Embodiment

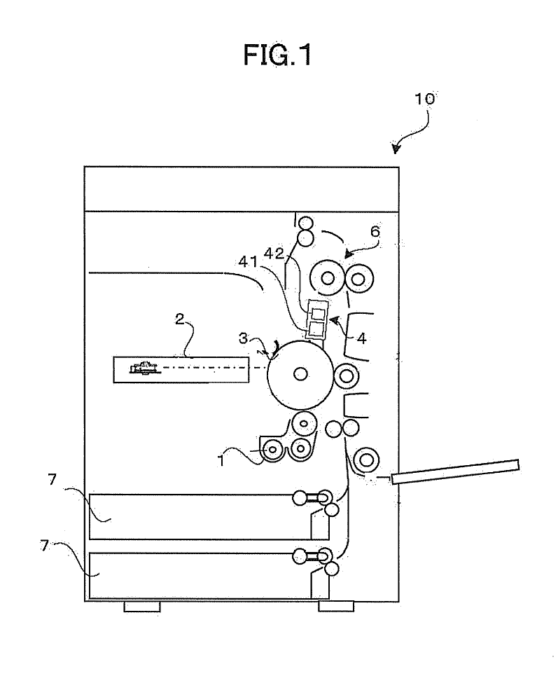

FIG. 1 is a skeleton diagram illustrating the image forming apparatus comprising the marking apparatus of the first embodiment.

The image forming apparatus 10 showed in FIG. 1 uses a color-fadable (color-erasable) material such as a color-fadable toner or color-fadable ink and the like to form the image on the sheet. The color-fadable material includes a color generation compound, a color developing agent and a color fading agent. For the color generation compound, for example, a leuco dye can be listed. For the color developing agent, for example, a phenol group can be listed. For the color fading agent, a substance which compatibilizes with the color generation compound when being heated, and furthermore, does not have affinity with the color developing agent can be listed. The color-fadable material develops the color by the interaction of the color generation compound and the color developing agent, and as the interaction of the color generation compound and the color developing agent is eliminated by the heating above a color fading temperature, the color-fadable material is subjected to the color fading.

The image forming apparatus 10 contains a heating color-fadable toner to be subjected to the color fading by the heating inside a developer 1. The heating color-fadable toner, for example, is the toner (fadable toner) after a color material whose color becomes colorless by the heating based on a thermoplastic resin is dispersed, and has the property of becoming colorless and transparent when reaching a temperature above about 120 degrees centigrade.

When the image formation is carried out, for example, a laser exposing unit 2 is controlled based on image data from a personal computer, and the light exposure corresponding to the image data is carried out on a photoreceptor 3. Thus, an electrostatic latent image is formed on the photoreceptor 6.

Next, by the heating color-fadable toner of the developer 1, the electrostatic latent image on the photoreceptor 3 is developed by the color-fadable toner. A toner image is transferred on the sheet fed from a paper cassette 7 at a transfer position by the static electricity of a transfer component 5, and a fixing apparatus 6 fixes the color-fadable toner on the sheet by the heating and pressurization. Afterwards, for the color-fadable toner image formed on the sheet, when the color-fadable toner is heated with the temperature higher than a fixing temperature, the color-fadable toner image is subjected to the color fading, and thus, the sheet becomes a white sheet.

In the present embodiment, the marking apparatus 4 printing the marker is configured in a sheet conveyance path between the transfer component 5 and the fixing apparatus 6. The marking apparatus 4 uses the record material with a heating coloring property to print the marker at the specified position of the sheet conveyed to the fixing apparatus 6.

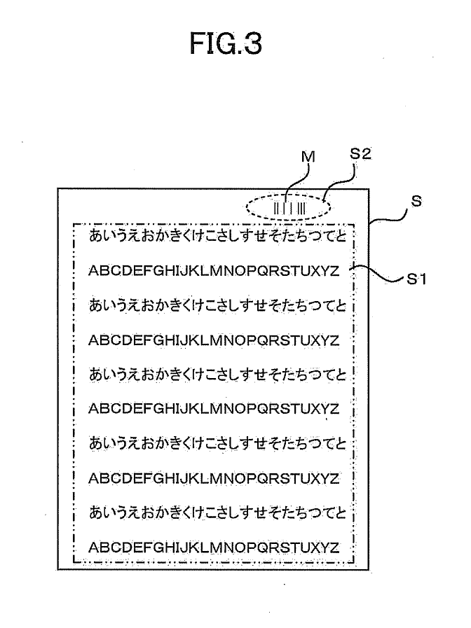

FIG. 3 illustrates an example of a marking position. In FIG. 3, on the sheet S, the image formed by the color-fadable toner to be subjected to the color fading by the heating is formed in an image forming area S1, and the marker M printed by the marker printing apparatus 4 is printed in a marker printing area S2 outside the range of the image forming area S1. The marker M, for example, uses identification information with a reuse time, such as a bar code and the like. In addition, in the marker printing apparatus 4, a capturing element including a CCD or CMOS reading the marker and a reading unit 41 of an image processing unit are configured at positions which approach the upstream side of a conveyance direction more than the marker printing unit 42.

The reading unit 41 reads the printing time of the marker M in the marker printing area S2 and enables the marker printing unit 42 to increase the printing time by 1 to carry out the printing by a printing control unit 43. In addition, in the condition that the sheet is not used, as the marker M is not read, the printing control unit 43 indicates the printing time 1 towards the marker printing unit 42, so that the marker printing unit 42 carries out the printing on the sheet. In addition, when the reuse time is increased by 1 each time, the printing is carried out at a novel position.

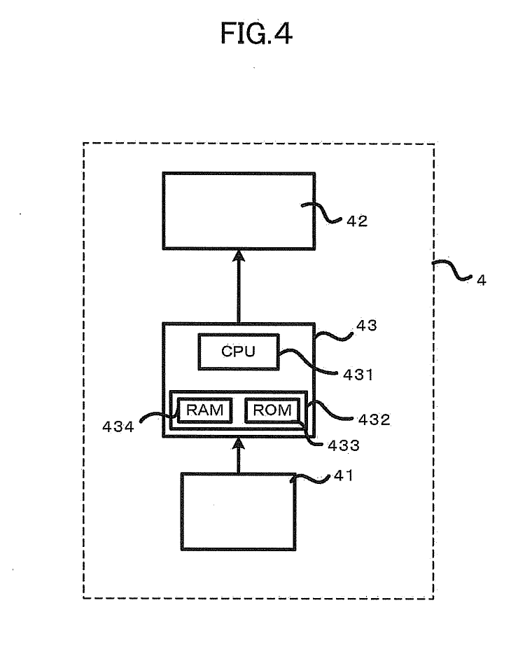

As shown in FIG. 4, the printing control unit 43, for example, comprises a processor 431 consisting of a CPU, and a memory unit 432. The memory unit 432, for example, comprises an ROM 433 using a semiconductor memory to store various control programs, and an RAM 434 providing a temporary working area for a primary memory 431. The image of the marker M read by using the reading unit 41 is processed by the processor 431, and thus, the reuse time and the like are differentiated.

In the present embodiment, the record material including the heating coloring property of the marking apparatus 4 has the reversibility of rendering the color at a coloring temperature higher than the fixing temperature, and moreover, becoming colorless at the fixing temperature. Therefore, the marker M printed near the fixing apparatus 7 becomes colorless in the state of passing through the fixing apparatus 7, and thus, the image formed by the color-fadable toner in the image forming area S1 only exists on the sheet S as a visual image.

Afterwards, when the sheet S on which the color-fadable toner image subjected to image visualization and the marker M are printed enters a color fading apparatus which is not shown in figures or passes through the fixing apparatus 6 heated to the color fading temperature, the color-fadable toner image is subjected to the color fading, and the marker M is visualized. Therefore, the condition that the sheet S of the white sheet is the reuse sheet can be discriminated according to the marker M. In addition, by using a number to denote the reuse time on the marker M, a user can refer to the reuse time to judge the service life and the like of the sheet S.

As the record material with the properties of the coloring at a specific temperature and the color fading at the specific temperature, for example, the toner for electronic photographic recording disclosed in the Japanese patent application publication No. 5-72800 report can be exemplified; the toner for the electronic photographic recording is characterized by comprising a reversible hot coloring colorant consisting of an electron releasing color generation compound and an electron acceptability compound, moreover, forming a coloring state by the heating and fusion, and forming a color fading state by the heating at the temperature lower than the coloring temperature.

The colorant included in the toner has the reversible hot coloring property, and therefore, renders the color instantaneously by the heating; the colorant (color renderer) in the coloring state also exists stably in a normal temperature; on the other hand, the colorant in the coloring state instantaneously fades the color by the heating below the coloring temperature; and the colorant (color fader) in the fading state also exists stably at the normal temperature. The colorant is in the state of the color fader below a specified color fading temperature (T0).

The colorant in the state of the color fader renders the color by being heated at the temperature above a specified coloring temperature (T1) higher than the color fading temperature (T0). Even though the temperature below the color fading temperature (T0) recovers, the color renderer also keeps the original state, and therefore, the color renderer has a memory property.

Next, in order to carry out the fading of the color renderer, it becomes the state of the color fader by heating the color renderer to the temperature lower than the coloring temperature and between T0 and T1. Even though the state of the color fader recovers to the temperature below T0, the original state of the color fader is also maintained. That is, the action properties of the formation and the fading of the color renderer have the reversibility, and the formation and the fading can be carried out repeatedly for many times.

The toner uses the reversible hot coloring colorant consisting of the electron releasing color generation compound (hereinafter, also called as coloring agent simply) and an electron acceptability compound (hereinafter, also called as coloring agent simply) as an essential ingredient. Afterwards, the colorant forms the coloring state by the heating and the fusion of the coloring agent and the color developing agent forming the reversible hot coloring colorant; on the other hand, the coloring state is eliminated by the heating at the temperature lower than the coloring temperature; and the coloring state and the color fading state stably exist at the normal temperature.

Such a coloring and color fading mechanism is a mechanism based on the following properties: when the coloring agent and the color developing agent are heated, fused and mixed at the coloring temperature, the colorant consisting of the coloring agent and the color developing agent generates non-crystallization, thus, the color renderer is formed, on the other hand, when the coloring agent and the color developing agent are heated at the temperature lower than the coloring temperature, the color developing agent in the colorant which has rendered the color generates crystallization, and thus, the color fader is formed.

However, when the ordinary coloring agent and the color developing agent, for example, become the color development state based on an open ring of a lactone ring of a leuco compound when a combination consisting of the leuco series compound used as a pigment precursor widely used in a conventional thermosensitive record sheet and having the lactone ring and a phenol compound showing a color development role is fused and mixed by the heating towards it.

The coloring state presents a non-crystalline state after the two (the coloring agent and the color developing agent) compatibilized. The non-crystalline state which has rendered the color stably exists at the normal temperature, even though the heating is carried out again, the crystallization also does not occur, as the separation from the leuco compound of the phenol compound does not exist, a closed ring of the lactone ring does not exist, and the color fading does not occur.

Relative to that, when the color developing agent of the toner used in the present embodiment and the colorant consisting of the color developing agent and the coloring agent are also fused and mixed by the heating, they become the color development state, and the non-crystalline state is presented similar to a conventional condition, so that they stably exist at the normal temperature. However, for the toner used in the present embodiment, when the colorant which has rendered the color and is in the non-crystalline state is heated at a temperature not reaching the color development temperature, that is, in a fusion state, the crystallization of the color developing agent occurs, the combination generated by the compatibilization state of the color developing agent and the coloring agent cannot be maintained, and the separation of the color developing agent from the coloring agent is caused. Afterwards, due to the separation of the color developing agent from the coloring agent, which is caused by the crystallization, it causes that the color developing agent cannot receive an electron from the coloring agent, and therefore, it can be thought that the coloring agent carries out the color fading.

Special coloring and color fading actions revealed by the colorant of the toner used in the present embodiment are relevant to the following items: the compatibility of the coloring agent and the color developing agent based on the heating and the fusion; the strength of the action of the two (coloring agent and color developing agent) in the color development state; the compatibilization capacity of the color developing agent towards the coloring agent; and the crystallinity and the like of the color developing agent; however, in principle, the non-crystallization caused by the heating and the fusion occurs; and on the other hand, if it is the color developing agent/color developing agent series whose crystallization is caused by the heating at the temperature lower than the color development temperature, a colorant ingredient as the toner can be utilized. In addition, as the substance with such a property shows the endothermal change caused by the fusion in thermal analysis and the coloring change caused by the crystallization, the available color developing agent/color developing agent series can be confirmed quite easily by the thermal analysis.

The color developing agent of the toner used in the present embodiment is the compound showing electron releasing, the color developing agent itself is a colorless or light dye precursor, but is not particularly limited, and the substance known conventionally, such as a triphenyl methane phthalide series compound, a fluoran series compound, a phenothiazine serial compound, a leuco auramine series compound, an indolinone phthalide series compound and the like, can be used.

In the present embodiment, the fixing temperature on the surface of a fixing roller of the fixing apparatus 7 is set as a temperature which is lower than the color fading temperature and is about 100 degrees centigrade. In addition, the printing of the marker M formed based on the record material rendering the color by the heating, which is carried out by using the marking apparatus 4, can be also a working procedure after the fixing apparatus 6. In the present embodiment, the printing apparatus 4 is a printing apparatus with heating coloring ink and in a stamp type, so long as it is the apparatus which can carry out recording on the record medium by using the record material rendering the color by the heating; and moreover, the record material rendering the color by the heating is not limited to the ink and the toner, so long as it has the function of rendering the color by the heating and can carry out transferring (printing) on the record medium such as the sheet and the like.

### A Second Embodiment

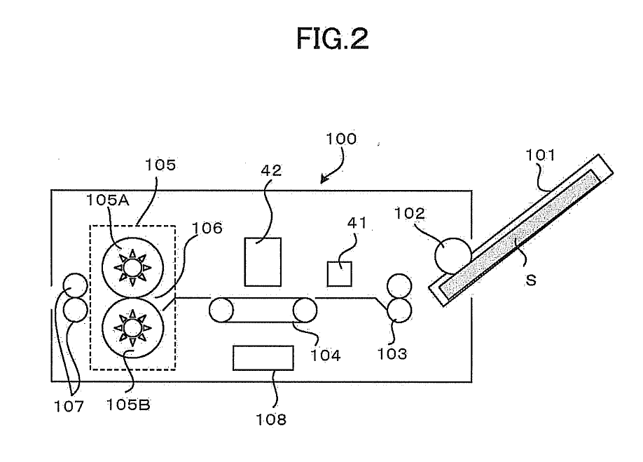

FIG. 2 is a skeleton diagram illustrating a color fading apparatus comprising the marking apparatus of the second embodiment.

The color fading apparatus 100 shown in FIG. 2 feeds the sheet S contained in a sheet feed unit 101 one by one to one pair of alignment rollers 103 by a sheet feed roller 102. The pair of alignment rollers 103 feed the sheet S to a conveyance unit 104 at a specified timing. The sheet S on the conveyance unit 104 is heated at the color fading temperature after passing through a nip unit 106 formed by a heating roller 105A and a pressurization roller 105B of a heating fading unit 105. Afterwards, the sheet S passing through the nip unit 106 is discharged outside equipment by one pair of sheet discharge rollers 107. In addition, for example, halogen lamps are respectively contained in the heating roller 105A and the pressurization roller 105B as heating sources.

On the sheet S, the color-fadable toner image formed by the color-fadable toner is formed on double surfaces or a single surface, and the color-fadable toner image is subjected to the color fading in the heating unit 104.

On the other hand, the reading unit 41 and the marker printing unit 42 of the marking apparatus shown in FIG. 4 are configured between the one pair alignment rollers 103 and the heating fading unit 105. The reading unit 41 configures the marker printing unit 42 at the upstream side of the conveyance direction at a downstream side. In the present embodiment, the marker printing unit 42 is constituted in an ink jet type, and the coloring ink which is colorless between the normal temperature and the color fading temperature and renders the color at the color fading temperature is used for printing the marker M in the marker printing area S2.

The heating unit 105, for example, carries out the heating and the color fading on the toner image obtained by the printing by using the heating color-fadable toner at the color fading temperature of 125 degrees centigrade. In addition, the heating control under a coloring temperature belt is carried out on the marker M of the coloring ink, obtained by the printing of the marker printing unit 42, to enable it to render the color. In the present embodiment, the color fading temperature and the coloring temperature are set as the same temperatures, and on the sheet S of the white sheet after the color-fadable toner image is subjected to the color fading, the marker M in the marker printing area S2 develops the color to become the visual image. In addition, a cooling fan 108 is used for cooling the marker M obtained by the printing of the marker printing unit 42, so that the maker N obtained by the printing of the marker printing unit 42 is not heated.

The printing control unit 43 outputs an instruction of forming the maker M with the reuse time after the reuse time included in the information of the marker M which is read by the reading unit 41 is increased by 1 to the marker printing unit 42. In addition, in the condition that the marker M is not read, the reuse time is judged to be 0, and the instruction of forming the marker M with the reuse time 1 to the marker printing unit 42.

That is, the sheet S discharged outside the equipment after passing through the heating unit 105 is the white sheet except the marker M, and therefore, the sheet S can be immediately judged to be the reuse sheet. Afterwards, the image is formed by the image forming apparatus shown in FIG. 1, and when the sheet passes through the fixing apparatus 7, the maker M becomes colorless.

As the marking apparatus mounted in the color fading apparatus, the ink jet type is taken for example for description, but it is not limited to the type, and it can be also an apparatus and a mechanism transferring the record material rendering the color by the heating on the record medium. At the moment, as the marker M, such a comment that the present sheet is the sheet used by color-fadable toner can be also printed, and the bar code in FIG. 3 is not printed. In such a condition, by enabling the hot coloring record material of the marking apparatus to be the reversible hot coloring material, the temperature color fading of carrying out the reversible color fading is included in a fixing temperature area of the hot color-fadable toner of the image forming apparatus shown in FIG. 1, thus, when the image formation is carried out by using the hot color-fadable toner, the comment outside an image area is subjected to the color fading, and next, in the heating color fading apparatus shown in FIG. 2, that it can be identified by using the color after the hot coloring when the heating color fading is carried out on the hot color-fadable toner can be realized.

For the processing described in FIG. 4, the condition that an internal data processing processor is enabled to execute the program previously stored in a storage area arranged in the image forming apparatus (color fading apparatus) is exemplified, but the program can be also downloaded to the image forming apparatus (color fading apparatus) from a network, and a content stored in the recoding medium of a computer-readable program can be also installed in the image forming apparatus (color fading apparatus). As the record medium, it can be the record medium so long as it can store the program, and furthermore, is computer-readable. As the record medium, for example, the RAM (Random Access Memory), the ROM (Read Only Memory), a DRAM, a SRAM (Static Random Access Memory), a VRAM (video RAM) and a flash memory can be used.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A marking apparatus, configured in an image forming apparatus for forming an image on a sheet by using a fadable record material which is faded when the heat with a specified fading temperature is applied, and to mark a marker at a specified position of the sheet, comprising:
a marking record material configured to color when the heat in a first temperature range is applied, fade the color when the heat in a second temperature range lower than the first temperature range is applied, and have the reversibility of alternately carrying out color-fading and coloring;
a marker printing unit configured to print the marker at the specified position of the sheet by using the marking record material; and
a heating unit configured to heat the marker in the second temperature range.

2. The marking apparatus according to claim 1, wherein
the fadable record material is an fadable toner, the heating unit is a fixing unit for fixing the fadable toner by a fixing temperature in the second temperature range, and the marker printing unit is arranged at the upstream side or the downstream side of a sheet conveyance direction of the fixing unit.

3. The marking apparatus according to claim 2, further comprising:
a reading unit configured to read the marker printed on the sheet; and
a printing control unit configured to enable the marker printing unit to print specified marking information to the marker printing unit based on read information read by the reading unit.

4. The marking apparatus according to claim 1, wherein
the information of marker contains the number of reuses.

5. A marking apparatus, configured in a fading apparatus for fading an image formed on a sheet by using a fadable record material which is faded when the heat with a specified fading temperature is applied, and to mark a marker at a specified position of the sheet, comprising:
a marking record material configured to color when the heat in a first temperature range is applied, fade the color when the heat in a second temperature range lower than the first temperature range is applied, and have the reversibility of alternately carrying out color-fading and coloring;
a marker printing unit configured to print the marking record material at the specified position of the sheet; and
a heating unit configured to heat the marker in the first temperature range.

6. The marking apparatus according to claim 5, wherein
the fadable record material is an fadable toner, the heating unit is a fading unit for fading the fadable toner by a fading temperature in the first temperature range, and the marker printing unit is arranged at the upstream side of a sheet conveyance direction of the fading unit.

7. The marking apparatus according to claim 6, further comprising:
a reading unit configured to be arranged at the upstream side of a sheet conveyance direction of the fading unit, and read the marker printed on the sheet; and
a printing control unit configured to enable the marker printing unit to print specified marking information to the marker printing unit based on read information read by the reading unit.

8. The marking apparatus according to claim 5, wherein
the information of marker contains the number of reuses.
